(19) United States
(12) Patent Application Publication
(10) Pub. No.: US 2004/0069238 A1
(43) Pub. Date: Apr. 15, 2004

(54) Animal habitat

(76) Inventor: David E. Haskins, Tiverton (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/268,887

(22) Filed: Oct. 11, 2002

(51) Int. Cl. A01K 63/00

(52) U.S. Cl. 119/245

(57) ABSTRACT

An animal habitat which includes a unitary base having at least one wall portion, and the base is provided with a receptacle. The habitat also includes a transparent glass portal configured to mate with the receptacle. The base and portal are configured to form a substantially enclosed space when the glass portal is mated with the receptacle. Typically the base is formed of injection-molded plastic.

### FIELD OF THE INVENTION

This invention relates to the field of animal habitats, with particular but by no means exclusive application to fish tanks.

### BACKGROUND OF THE INVENTION

Standard tanks used for fish and other animal habitats tend to be made with glass panels for the floor and four side walls, with metal or other materials joining the panels together. As a result, these tanks are very heavy, with larger tanks weighing hundreds of pounds. Other tanks have all of the panels made from transparent plastic. However, over time as the plastic panels are cleaned, they become scratched thereby diminishing their transparency.

Accordingly, the inventor has recognized the need for an improved fish tank to address these disadvantages.

### SUMMARY OF THE INVENTION

The animal habitat of the present invention includes a unitary base having at least one wall portion. The base is provided with a receptacle. The habitat also includes a transparent glass portal configured to mate with the receptacle. The base and portal are configured to form a substantially enclosed space when the glass portal is mated with the receptacle.

In another aspect, the animal habitat of the present invention includes a unitary base having at least one wall portion. The base is provided with at least one receptacle and at least one transparent glass portal configured to mate with the at least one receptacle. The base and the at least one portal are configured to form a substantially enclosed space when the at least one glass portal is mated with the at least one receptacle.

### BRIEF DESCRIPTION OF THE DRAWINGS

The present invention will now be described, by way of example only, with reference to the following drawings, in which like reference numerals refer to like parts and in which:

FIG. 1 is a front perspective view of an animal habitat, made in accordance with the present invention;

FIG. 2 is a front perspective view of the animal habitat of FIG. 1 with the portal removed;

FIG. 3 is a close-up view of the top front left corner of the base of the animal habitat of FIG. 1, with the portal removed;

FIG. 4 is a schematic diagram of a portion of a water filtration system of the animal habitat of FIG. 1.

FIG. 5 is a front perspective view of a first alternate embodiment of an animal habitat made in accordance with the present invention.

FIG. 6 is a front perspective view of a second alternate embodiment of an animal habitat made in accordance with the present invention.

FIG. 7 is a front perspective view of the animal habitat of FIG. 1 with a lid and a support stand.

### DETAILED DESCRIPTION OF THE INVENTION

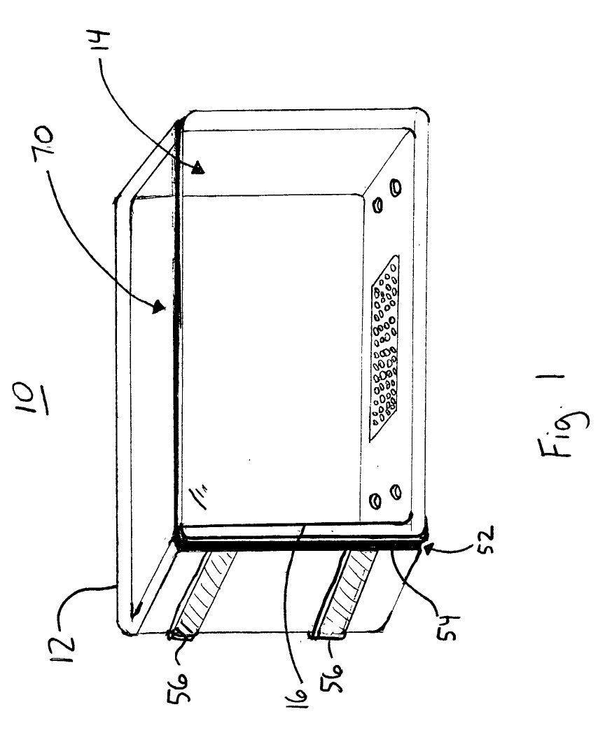

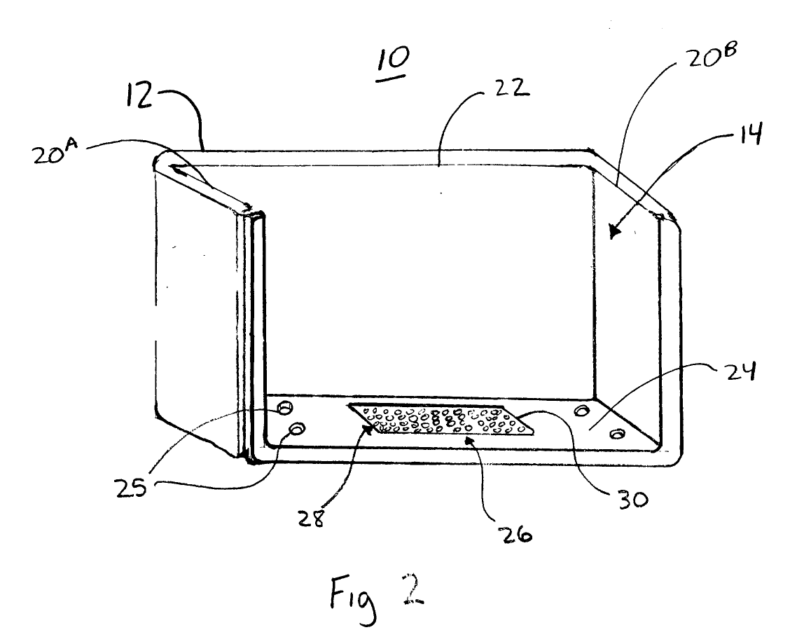

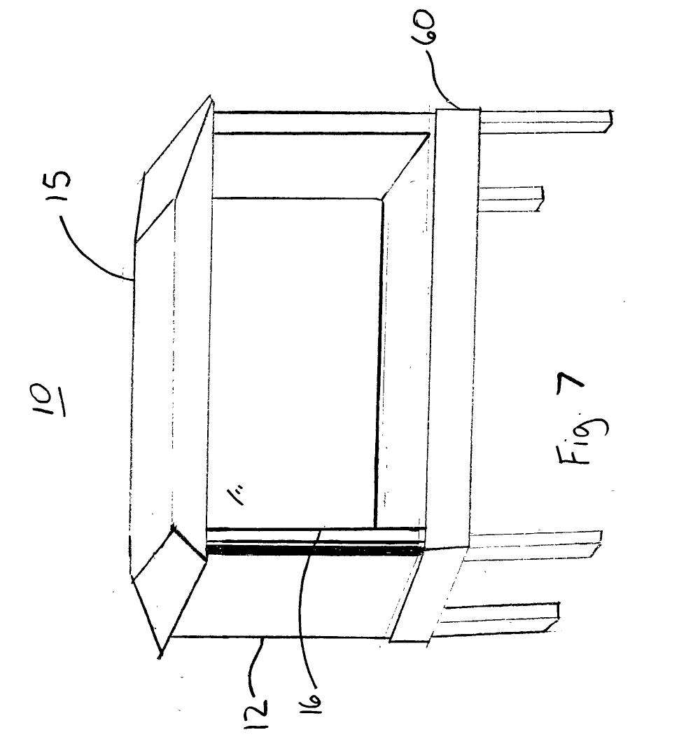

Referring simultaneously to FIGS. 1 and 2, illustrated therein is an animal habitat, referred to generally as 10, made in accordance with the present invention. The animal habitat 10 comprises a base unit 12, a portal receptacle 14 formed in the base unit 12, and a portal 16 sized and shaped to fit within the receptacle 14. As shown in FIG. 7, the habitat may be provided with a lid 15, to keep dust and other debris from falling into the confined space and to enclose a lighting system.

The base unit 12 is preferably formed from molded plastic, which is both lightweight and has sufficient structural strength, as will be understood. The plastic may be transparent, translucent or opaque, and may be coloured or colourless. However, plastic is generally susceptible to developing scratches over time. As a result, it is generally preferable for the plastic to be coloured and translucent or opaque, with a textured surface to obscure the appearance of scratches.

Typically, the base unit 12 will be unitary in that it is formed in a single piece through injection molding, although other suitable forming techniques may be used. The base unit 12 generally has two side walls 20A, 20B, a rear wall 22 and a floor 24. Plant holders 25 may also be formed into the floor 24 of the habitat 10 for receiving and holding aquatic plants, if the habitat 10 is to be used as a fish tank.

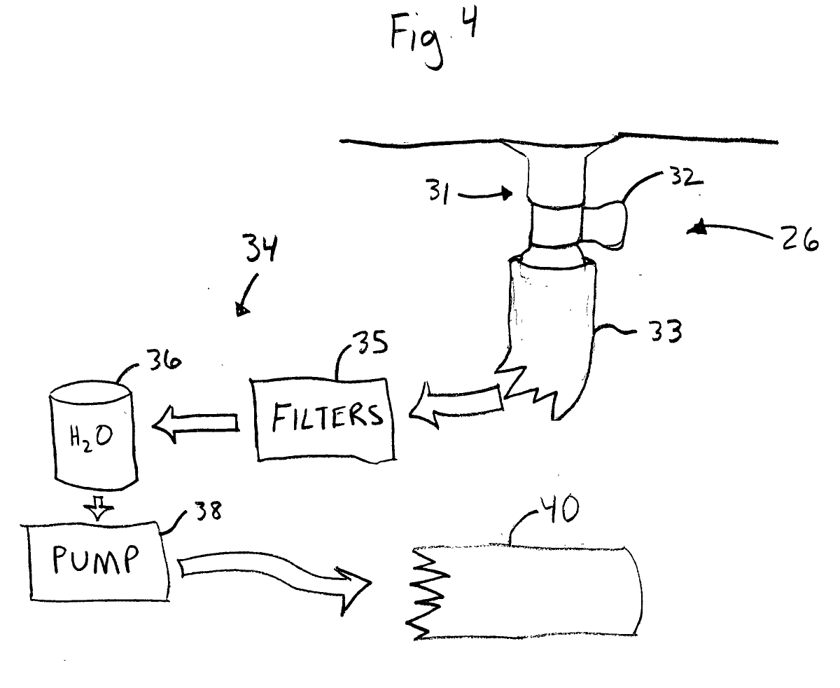

Referring now to FIGS. 2 and 4, the animal habitat may also comprise a water filtration system 26. The filtration system 26 may include a water intake hole 28 molded into the floor 24 of the base unit 12 and preferably having a removable grill 30 with small enough apertures to support gravel and other materials typically lining the floor of a fish tank, while enabling water to be drawn into the intake 28. The intake hole 28 may be coupled to a discharge outlet 31 having a shut-off valve 32. A filtering system 34, such as the Hagen FLUVAL (TM) MSF 404 canister filtration system, which includes a series of filters 35, a water reservoir 36, a pump 38, and a water return tube 40, may be connected to the discharge outlet 31 by an intake tube 33. As will be understood, the return tube 40 may be hooked over one of the side walls 20A, 20B or the rear wall 22 of the habitat 10, to return filtered water to the interior space 70.

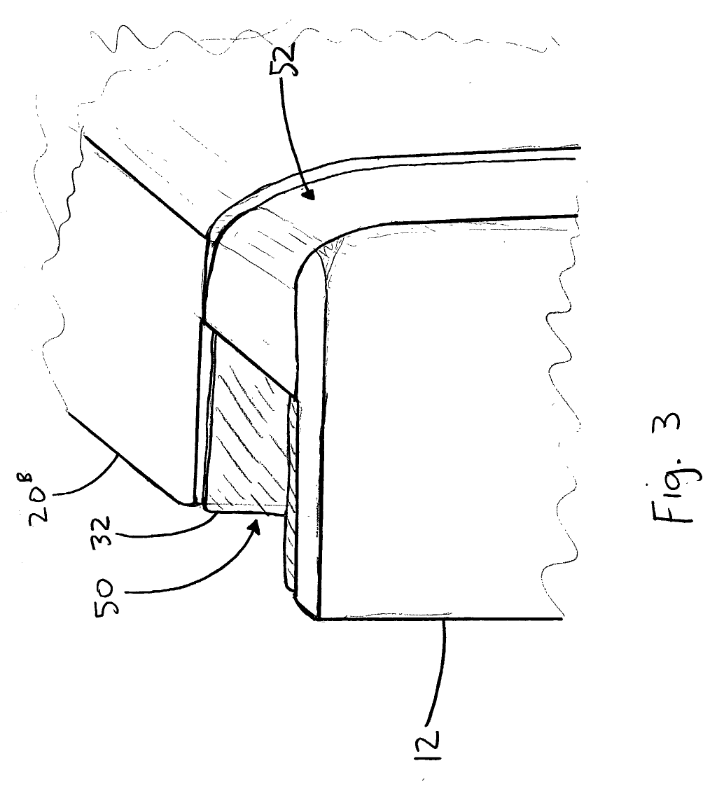

The portal 16 is formed of transparent glass. Typically, the glass is formed in a pane and preferably with rounded corners, but as will be understood, the glass may be curved or otherwise shaped. As can be seen in FIG. 3, an interior portal groove 50 is typically formed in the base unit 12 around a portion of the periphery of the portal receptacle 14. In turn, the portal groove 50 is sized to receive a portion of the periphery of the portal 16 and secure it in place. The portal 16 and base unit 12 form a confined space shown generally as 70, in which an animal may be housed and viewed through the portal 16.

If the habitat 10 is to be used as a fish tank, a rubber seal 32 or other water-tight sealant may be provided between the inside groove 50 and the portal 16. A coupler may be provided for assisting in mating the portal 16 to the base unit 12. For example, for added strength, the coupler may include an external groove 52 formed in the exterior surface of the base unit 12, adjacent the periphery of the portal receptacle 14. The exterior groove 52 is sized to receive a sealing band 54 (which may also form part of the coupler) of steel, plastic or other sufficiently strong material which may be cinched around the exterior groove 52 and clamped or otherwise fixed in place to strengthen the seal between the portal 16 and the base unit 12.

One or more structural support members such as support bars 56 typically formed of steel, plastic or other sufficiently strong material and generally tubular, may be provided around the periphery of the base unit 12 to provide additional structural support. A support bar 56 may be aligned in a generally horizontal plane (as shown in FIG. 1), or in a generally vertical plane, depending on the structural support to be provided, as well as the shape of the base unit 12. The support bar 56 may be aligned in other planes, however. The support bar 56 is typically coupled to the sealing band 54.

As shown in FIG. 7, the habitat 10 may also be provided with a stand 60 for supporting the base unit 12 and providing additional structural support, and for hiding some of the water filtration system 26 from view.

While the typical configuration of the base unit 12 will have side walls 20A, 20B, a rear wall 22 and a floor 24 (and forming a substantially rectangular shape from a top plan view), it should be understood that the base unit 12 may be formed in a shape, for example, generally obround or ellipsoidal, such that the base 12 has at least one wall (possibly curviplanar), but not necessarily the three walls 20A, 20B, 22 and floor 24 shown in FIG. 1, while still forming a substantially enclosed space with a portal. Alternate base 12 configurations are also possible.

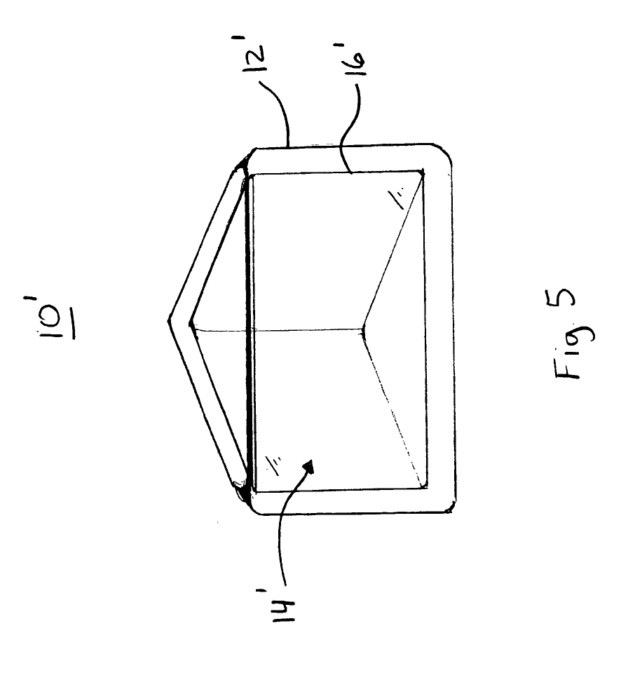

For example, referring now to FIG. 5, illustrated therein is a front perspective view of a first alternative embodiment of the animal habitat of the present invention, shown generally as 10′. The animal habitat 10′ comprises a base unit 12′, a portal receptacle 14′ formed in the base unit 12′, and a portal 16′ sized and shaped to fit within the portal receptacle 14′. The base 12′ is generally triangular in shape from the top plan view.

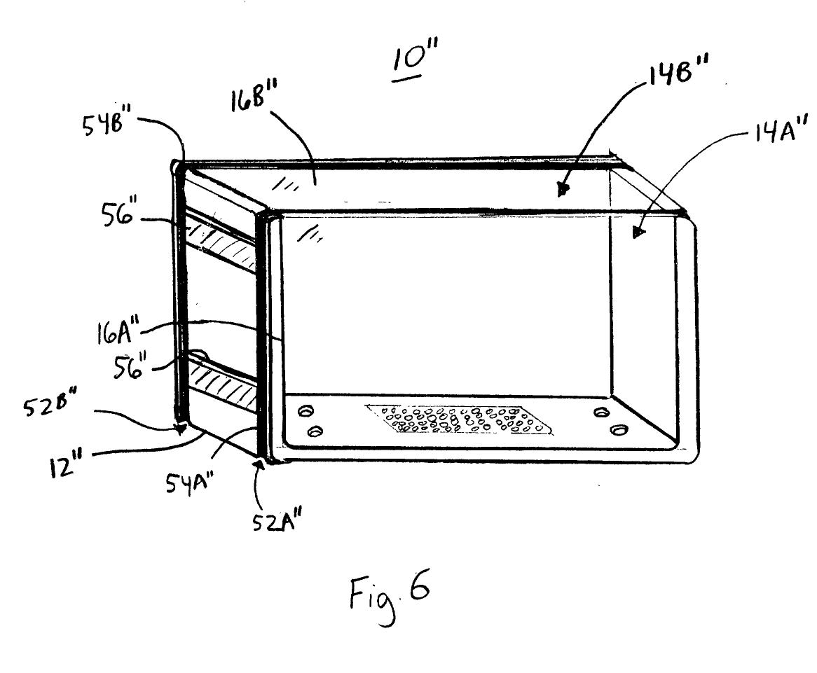

Referring now to FIG. 6, illustrated therein is a front perspective view of a second alternative embodiment of the animal habitat of the present invention, shown generally as 10″. The animal habitat 10″ comprises a base unit 12″, a front portal receptacle 14A″ formed in the base unit 12″, a rear portal receptacle 14B″ formed in the base unit 12″, a front portal 16A″ and a rear portal 16B″ sized and shaped to fit within the front 14A″ and rear 14B″ portal receptacles, respectively.

Couplers may be provided for assisting in mating the portals 16A″, 16B″ to the base unit 12″. For added strength, the couplers may include external grooves 52A″, 52B″ formed in the exterior surface of the base unit 12″, adjacent the periphery of the portal receptacles 14A″, 14B″. The exterior grooves 52A″, 52B″ are similar to the groove 52 of FIG. 1 and are each sized to receive a sealing band 54A″, 54B″ (which may also form part of the coupler) of steel, plastic or other sufficiently strong material which may be cinched around the respective exterior groove 52A″, 52B″ and clamped or otherwise fixed in place to strengthen the seal between the portals 16A″, 16B″ and the base unit 12″.

Support bars 56″ typically formed of steel, plastic or other sufficiently strong material and generally tubular, may be provided along the outer sides of the base unit 12″ (only one side shown) to provide additional structural support. The support bar 56″ is typically coupled to the sealing bands 54A″, 54B″.

Thus, while what is shown and described herein constitutes preferred embodiments of the subject invention, it should be understood that various changes can be made without departing from the subject invention, the scope of which is defined in the appended claims.

1. An animal habitat, comprising:
(a) a unitary base having at least one wall portion, wherein the base further comprises a receptacle;
(b) a transparent glass portal configured to mate with the receptacle; and
(c) wherein the base and the portal are configured to form a substantially enclosed space when the glass portal is mated with the receptacle.

2. The habitat of claim 1, wherein the base is substantially formed of molded plastic.

3. The habitat of claim 2, wherein the base is substantially formed of injection molded plastic.

4. The habitat of claim 2, wherein the receptacle comprises a portal groove configured to engage a portion of the portal.

5. The habitat of claim 4, further comprising a coupler for mating the portal with the receptacle.

6. The habitat of claim 5 wherein the coupler comprises a sealing band positioned proximate the portal groove.

7. The habitat of claim 1, further comprising at least one structural support member configured to provide structural support to the base.

8. The habitat of claim 7, wherein the at least one support member comprises a support bar positioned proximate the outer surface of the base.

9. The habitat of claim 1, wherein the portal comprises a glass pane.

10. The habitat of claim 1, wherein the habitat is configured with a substantially rectangular shape from a top plan view.

11. The habitat of claim 1, wherein the habitat is configured with a substantially triangular shape from a top plan view.

12. An animal habitat, comprising:
(a) a unitary base having at least one wall portion, wherein the base further comprises at least one receptacle;
(b) at least one transparent glass portal configured to mate with the at least one receptacle; and
(c) wherein the base and the at least one portal are configured to form a substantially enclosed space when the at least one glass portal is mated with the at least one receptacle.

13. The habitat of claim 12, further comprising a seal between the at least one portal and the at least one receptacle.

14. The habitat of claim 12,
(a) wherein the at least one transparent glass portal comprises a first transparent glass portal and a second transparent glass portal;
(b) and wherein the at least one receptacle comprises a first receptacle and a second receptacle;
(c) wherein the first portal is configured to mate with the first receptacle; and
(d) wherein the second portal is configured to mate with the second receptacle.
